(19) United States
(12) Patent Application Publication
(10) Pub. No.: US 2009/0256432 A1
(43) Pub. Date: Oct. 15, 2009

(54) Motor

(75) Inventors: Pyo Kim, Suwon-si (KR); Kyung-Seob Shin, Ansan-si (KR); Young-Sun Yoo, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANCS CO., LTD., Suwon (KR)

(21) Appl. No.: 12/232,089

(22) Filed: Sep. 10, 2008

(30) Foreign Application Priority Data
Apr. 10, 2008 (KR) 10-2008-0033074

(51) Int. Cl. H02K 37/10

(52) U.S. Cl. 310/46

(57) ABSTRACT

A motor is disclosed, which includes: a rotor, to an inside of which a magnet is coupled, and from a center portion of which a tube-shaped cylindrical portion protrudes out; a shaft, which has one end coupled to the cylindrical portion, where the outer diameter of the one end of the shaft is greater than that of the other side; a holder, which supports the other end of the shaft, and which has a portion inserted in the cylindrical portion; a bearing, which is positioned between the holder and the other end of the shaft, and which rotatably supports the other end of the shaft; a stator, which is adjacent to the magnet, and which has a coil wound around a portion; and a base, which supports the holder. This motor may be utilized to better maintain verticality in the shaft of the motor and prevent wobbling in the disk.

### CROSS-REFERENCE TO RELATED APPLICATIONS

This application claims the benefit of Korean Patent Application No. 10-2008-0033074 filed with the Korean Intellectual Property Office on Apr. 10, 2008, the disclosure of which is incorporated herein by reference in its entirety.

### BACKGROUND

1. Technical Field

The present invention relates to a motor.

2. Description of the Related Art

With the increase in usage of information storage media such as optical disks, etc., the user requirements in ODD's, CD-ROM drives, DVD drives, etc., which utilize such storage media, are becoming more varied. Also, electronic equipment that employ ODD's, CD-ROM drives, DVD drives, etc., are becoming smaller and lighter. Thus, smaller and thinner products are being developed for ODD, CD-ROM drive, and DVD drive devices, in correspondence to such trends towards smaller and lighter electronic equipment.

To satisfy these requirements for thinner products, the overall height of the spindle motor used in an ODD, CD-ROM drive, DVD drive, etc., is decreasing. In the related art, if the overall height of the spindle motor is decreased, the height of the shaft support system in the motor may also be decreased. As such, with a spindle motor based on the related art, it may be difficult to maintain verticality and prevent wobbling in the motor.

### SUMMARY

An aspect of the invention provides a motor in which the shaft support system can maintain substantially the same length as a shaft support system of an existing motor, even when the motor is provided with a smaller thickness.

Another aspect of the invention provides a motor that includes: a rotor, to an inside of which a magnet is coupled, and from a center portion of which a tube-shaped cylindrical portion protrudes out; a shaft, which has one end coupled to the cylindrical portion, where the outer diameter of the one end of the shaft is greater than that of the other side; a holder, which supports the other end of the shaft, and which has a portion inserted in the cylindrical portion; a bearing, which is positioned between the holder and the other end of the shaft, and which rotatably supports the other end of the shaft; a stator, which is adjacent to the magnet, and which has a coil wound around a portion; and a base, which supports the holder.

Here, the holder and the bearing may support the entirety of the other end of the shaft.

The cylindrical portion of the rotor can be formed to have a constant inner diameter.

A hook that protrudes outwards can be formed on an outer perimeter of the holder, and a stopper that may latch onto the hook can be formed on an inside of the rotor, where the hook can be positioned outside the cylindrical portion.

In certain embodiments, the motor can further include a chucking part that surrounds the cylindrical portion and is coupled to the rotor. The chucking part can include: a chuck base coupled to the cylindrical portion; chuck chips inserted in the chuck base in such a way that the chuck chips protrude out from the chuck base; and an elastic member, which is positioned inside the chuck base, and which elastically supports a pair of adjacent chuck chips in an outward direction of the chuck base.

Here, the elastic member may be a compression coil spring.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross sectional view of a motor according to an embodiment of the invention.

FIG. 2 is a detailed illustration of portion A in FIG. 1.

FIG. 3 is a bottom view of a chucking part according to an embodiment of the invention.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

The motor according to certain embodiments of the invention will be described below in more detail with reference to the accompanying drawings. Those components that are the same or are in correspondence are rendered the same reference numeral regardless of the figure number, and redundant explanations are omitted.

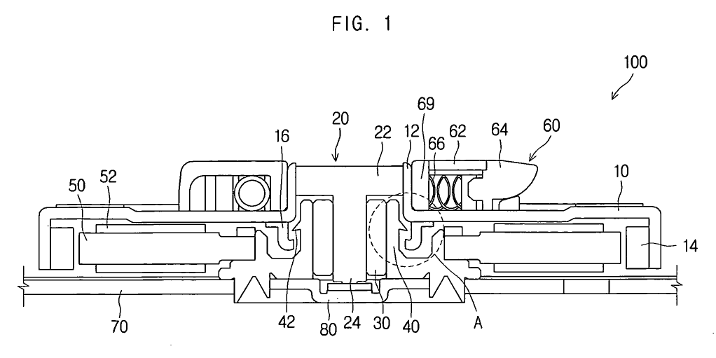

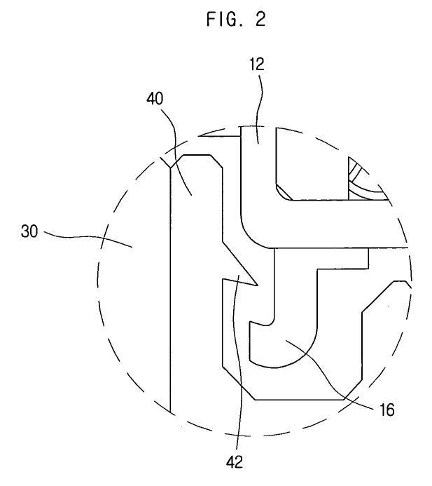

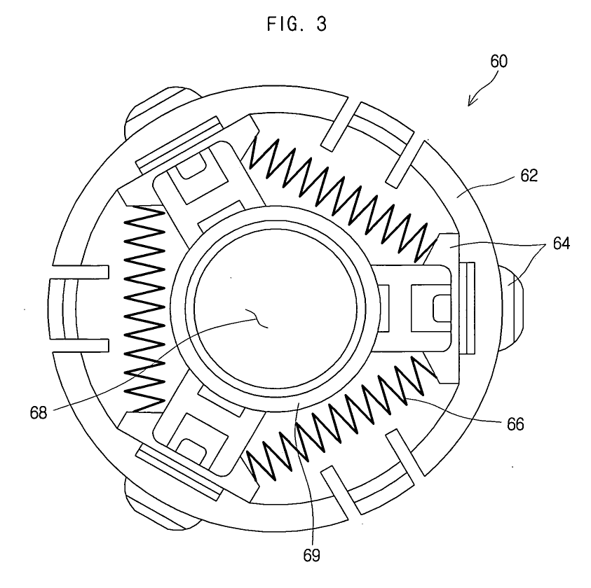

FIG. 1 is a cross sectional view of a motor according to an embodiment of the invention, FIG. 2 is a detailed illustration of portion A in FIG. 1, and FIG. 3 is a bottom view of a chucking part according to an embodiment of the invention. In FIGS. 1 to 3, there are illustrated a rotor 10, a cylindrical portion 12, magnets 14, a stopper 16, a shaft 20, one end 22 of the shaft, the other end 24 of the shaft, a bearing 30, a holder 40, a hook 42, a stator 50, coils 52, a chucking part 60, a chuck base 62, chuck chips 64, elastic members 66, a center hole 68, a boss 69, a base 70, a support 80, and a motor 100.

As illustrated in FIG. 1, an embodiment of the invention may provide a motor 100, which can include a rotor 10 that rotates and has magnets 14 coupled inside, a shaft 20 of which one end and the other end have different outer diameters, a holder 40 that supports the shaft 20 and has a portion inserted in a cylindrical portion 12, a bearing 30 positioned between the holder 40 and the shaft 20 to rotatably support the shaft 20, a stator 50 that has wound coils 52 and is positioned adjacent to the magnets 14, and a base 70 that supports the holder 40.

According to an embodiment of the invention, a chucking part 60 can be coupled to an upper portion of the rotor 10. The chucking part 60 can be the portion that secures a disk to be rotated by the motor 100, where the disk may be detachably secured to the chucking part. Of course, a turntable can also be coupled to the upper portion of the rotor 10, instead of a chucking part 60 such as that illustrated in FIG. 1, according to the usage of the spindle motor.

According to this embodiment, magnets 14 can be coupled inside the rotor 10. As in the example shown in FIG. 1, the rotor 10 can be shaped to cover the stator 50, bearing 30, and holder 40, and can have the magnets 14 coupled on the inner perimeter of the rotor 10. A cylindrical portion 12 can be formed protruding from a middle portion of the rotor 10 in the shape of a tube. The cylindrical portion 12 can be shaped as a tube having a circular cross section protruding outwards from an upper surface of the rotor. In this particular embodiment, the cylindrical portion 12 can be tube-shaped with a regular size, that is, with a constant inner diameter and a constant outer diameter.

A shaft 20 can be coupled to the cylindrical portion 12 formed in a center portion of the rotor 10, and as the magnetic field generated by the magnets 14 of the rotor interact with the stator 50, the rotor may rotate together with the shaft 20. The magnets 14 can be positioned facing the stator 50 adjacent to the stator 50, to generate a force for rotating the rotor 10.

The stator 50 can be located within the space covered by the rotor 10, adjacent to the magnets 14. Coils 52 may be wound around the stator 50, and when an electric current is applied through the coils, the stator may be magnetized. Then, the stator 50 and the magnets 14 of the rotor 10 can interact and provide a rotational force for the rotor 10. The stator 50 can be coupled to the base 70 or to the holder 40 secured to the support 80, to form a particular positional relationship with the rotor 10.

The base 70 may be coupled to the support 80 and the holder 40 to support the overall configuration of the motor. The base 70 may support the holder 40, which can maintain the verticality of the shaft 20.

The shaft 20 may be a rotating axis that is located at the rotation center of the motor and rotates together with the rotor 10. In this embodiment, one end of the shaft 20 can be coupled to the cylindrical portion 12. Because the one end 22 of the shaft may be secured to the cylindrical portion 12, the rotor 10 and the shaft 20 may rotate together. The one end 22 of the shaft coupled to the cylindrical portion 12 may have an outer diameter greater than that of the other end. The outer diameter of the one end 22 of the shaft can be formed greater than the outer diameter of the other end 24 of the shaft, in correspondence with the inner diameter of the cylindrical portion 12.

By forming the other end 24 of the shaft to have an outer diameter corresponding to the inner diameter of the cylindrical portion 12, the rotor 10 can be coupled to the one end 22 of the shaft through the cylindrical portion 12. That is, according to this embodiment, the cylindrical portion 12 illustrated in FIG. 1 can be formed with a constant inner diameter and can be formed protruding outwards from the rotor 10. The rotor 10 shown in FIG. 1 can be structured to have the cylindrical portion 12 formed in a regular size, with the shaft 20, which has different outer diameters in either end, coupled to the cylindrical portion 12.

Therefore, compared to the rotor used in a conventional motor in which the shaft has a constant outer diameter, the rotor 10 of a motor based on this embodiment may not require a two-stepped structure. That is, this embodiment uses a rotor that has a single step structure, i.e. at the cylindrical portion, instead of a two-stepped structure, which is more difficult to process with precise dimensions.

The bearing 30 can be interposed between the holder 40, which will be described below in more detail, and the other end 24 of the shaft, to rotatably support the other end 24 of the shaft. The bearing 30 may enclose the other end 24 of the shaft and allow the shaft 20 to rotate more smoothly. By rotatably supporting the other end 24 of the shaft, the bearing 30 may support the rotor 10 and the chucking part 60, which are coupled to the one end 22 of the shaft. The rotor 10 and the chucking part 60 can be supported in such a way that a disk secured to the chucking part 60 may be kept horizontal. In other words, when the shaft 20 is rotated, the bearing 30 can keep the shaft vertical, whereby slanting in the disk may be avoided and wobbling may be prevented.

Also, on the outer side of the bearing 30, a holder 40 can surround the bearing 30 and support the other end 24 of the shaft. The holder 40 can be coupled to the base 70 or the support 80 of the motor 100 and can enclose the bearing 30 to support the shaft 20. Here, the bearing 30 and the holder 40 may form a part of the shaft support system that maintains the verticality of the shaft 20. During the rotation of the shaft 20, the bearing 30, which may support the other end 24 of the shaft, and the holder 40, which may enclose and support the bearing 30, can secure the shaft 20 in a vertical position and thereby reduce wobbling in the disk.

According to this embodiment, in order to enlarge the portions of the bearing 30 and holder 40 supporting the shaft 20, i.e. in order to increase the height of the shaft support system, portions of the bearing 30 and the holder 40 can be inserted within the cylindrical portion 12. The bearing 30, which may support the other end 24 of the shaft, may extend to the inside of the cylindrical portion 12 to rotatably support the shaft 20, while the holder 40 may enclose the bearing 30, which may extend to the inside of the cylindrical portion 12, and support the shaft 20.

As illustrated in FIG. 1, the bearing 30 and the holder 40 may extend above the level of the upper surface of the rotor 10 and extend to the inside of the cylindrical portion 12, in supporting the other end 24 of the shaft. That is, the height of the shaft support system may be above the height of the upper surface of the rotor 10.

For maximum effectiveness in keeping the shaft 20 vertical, the bearing 30 and the holder 40 can surround the entire other end 24 of the shaft excluding the portion of the one end 22 of the shaft. The bearing 30 and the holder 40 can extend to the inside of the cylindrical portion 12 with substantially the same height. That is, the height of the shaft support system can be increased up to the boundary between the one end 22 and the other end 24 of the shaft where the difference in outer diameters occurs.

In this embodiment, the one end 22 of the shaft, which has a larger outer diameter, can be given a minimum thickness, so that the heights of the bearing 30 and the holder 40, i.e. the height of the shaft support system, can be increased and the verticality of the shaft can be maintained with maximum effectiveness.

As illustrated in FIG. 1, portions of the bearing 30 and holder 40 may be positioned inside the cylindrical portion 12, but there may be certain limits imposed on the size of the cylindrical portion 12, due to considerations regarding such factors as the configuration and position of the chucking part 60 formed on the outer side of the cylindrical portion 12. Thus, portions of the bearing 30 and the holder 40 may be inserted inside the cylindrical portion 12, but there may also be a particular amount of space required outside the cylindrical portion 12.

Thus, according to this embodiment, in order to make the inner diameter of the cylindrical portion 12 as small as possible within a range that allows the bearing 30 and the holder 40 to be inserted inside, the hook 42 formed on the outer perimeter of the holder 40 may be formed outside the cylindrical portion 12.

The hook 42 can be a detent protrusion that protrudes outward from the outer perimeter of the holder 40. A stopper 16 formed on the inside of the rotor 10 can latch onto the hook 42 to prevent the rotor 10 from becoming separated from the base 70 and the stator 50.

That is, as illustrated in FIG. 1 and FIG. 2, the hook 42 may not be inserted inside the cylindrical portion 12, and may instead be located outside the cylindrical portion 12 at a position lower than the cylindrical portion 12, so that the size of the cylindrical portion 12 may be minimized. As the size of the cylindrical portion 12 is minimized, the space required for installing components of the chucking part 60, which can be coupled to the rotor 10, may be obtained, while the length of the shaft support system may be increased.

Whereas the trends for thinner products of the spindle motor may require a lower overall height of the motor, the heights of the bearing 30 and the holder 40, which support the shaft 20, can be kept the same, with adjustments only in the position of the hook 42, the length of the shaft 20, and the height of the rotor 10, to provide a thin motor.

As illustrated in FIG. 1, a chucking part 60 can be installed on an upper portion of the rotor 10. The chucking part 60 may enclose the cylindrical portion 12 and may be coupled with the rotor 10. In this embodiment, the rotor 10 can have a single step structure, with the cylindrical portion 12 having a greater outer diameter than those of the related art, and the chucking part 60 may be structured as illustrated in FIG. 3.

As in the example shown in FIG. 3, the chucking part 60 can include a chuck base 62, which may be coupled to the cylindrical portion 12 and which may cover the internal components of the chucking part 60, a multiple number of chuck chips 64, which may be inserted in the chuck base 62 to protrude outwards of the chuck base 62, and elastic members 66, which may be positioned inside the chuck base 62 and which may each elastically support a pair of adjacent chuck chips 64 outwards from the chuck base 62.

In this embodiment, the elastic members 66 may be compression coil springs.

With the chuck base 62 coupled to the cylindrical portion 12, which may have a larger size due to the bearing 30 and the holder 40 inserted inside, the compression coil springs elastically supporting the chuck chips 64 inside the chuck base 62 may not be arranged in a radial configuration. Thus, in this embodiment, the compression coil springs may be arranged in a triangular configuration, with each spring elastically supporting a pair of adjacent chuck chips 64 in an outward direction of the chuck base 62. A disk may be mounted on and dismounted from the elastically supported chuck chips 64.

A more detailed description will be provided below on the chucking part 60, which can be coupled to a motor 100 based on this embodiment.

As illustrated in FIG. 3, a boss 69 can be formed on the chuck base 62. The chuck base 62 may hold and cover the components of the chucking part 60. The boss 69 may be formed on the inside of the chuck base 62 and may be coupled to the cylindrical portion 12 of the rotor 10.

The chuck base 62 may have a generally circular shape, and may have a center hole 68 formed in the middle. The cylindrical portion 12 of the rotor 10 can be inserted through the center hole 68 and secured. The chuck chips 64 may be inserted along the circumference of the chuck base 62 in particular intervals. The center hole 68 may be formed in the middle of the boss 69.

The chuck chips 64 may be inserted through the chuck base 62 and may protrude outwards, due to the elastic forces applied by the elastic members 66, to press the inner perimeter of a disk. In one example, three chuck chips 64 may be arranged around the center hole 68 at angles of 120 degrees. Thus, the chuck chips 64, and the elastic members 66 that elastically support the chuck chips 64, can be positioned in a generally triangular arrangement.

While the chucking part 60 coupled to the motor 100 described for this particular embodiment is illustrated with three elastic members 66 and three chuck chips 64, the invention is not thus limited, and it is to be appreciated that any of various numbers of chuck chips 64 and elastic members 66 may be included according to design conditions, etc. For example, four, five, or six chuck chips 64 may be arranged in particular intervals.

A chuck chip 64 can be pressed simultaneously by a pair of adjacent elastic members 66. Conversely, an elastic member 66 can simultaneously press a pair of adjacent chuck chips 64. Because two adjacent elastic members 66 may simultaneously press a chuck chip 64, even if the elasticity is different for each of the elastic members 66, the differences can be cancelled out to a certain degree.

Although the elastic members 66 used may be such that are all supposed to have the same elasticity, certain differences may occur during fabrication. Such differences in elasticity can cause misalignment between the center of the disk and the center of the chuck base 62. However, in a chucking part 60 based on this embodiment, one elastic member 66 may simultaneously press the pair of adjacent chuck chips 64, and one chuck chip 64 can be pressed simultaneously by the forces applied by the pair of adjacent elastic members 66.

As such, since the elastic members 66 may be linked together by way of the chuck chips 64, the differences in elasticity of the elastic members 66 can be distributed, to provide a generally self-adjusting configuration. The chucking part 60 may also be effective in responding to the decrease in space for installing components of the chucking part 60, resulting from the increased size of the cylindrical portion 12.

As described above, the elastic members 66 can be, for example, compression coil springs.

According to this embodiment, the one end 22 of the shaft can be coupled to the cylindrical portion 12 formed on the rotor 10, while the bearing 30 and the holder 40 can be inserted in the cylindrical portion 12 to maximize the length of the shaft support system, which supports the other end 24 of the shaft. Also, by positioning the hook 42, which may protrude outwards from the outer perimeter of the holder 40, on an outer side of the cylindrical portion 12, the size of the cylindrical portion 12 can be minimized, allowing more space for installing the chucking part 60, which may be coupled onto an upper surface of the rotor 10. Also, the chucking part 60 can be coupled to the cylindrical portion 12 with the elastic members 66 of the chucking part 60 arranged as illustrated in FIG. 3.

According to certain embodiments of the invention as set forth above, even when the overall height of a thin spindle motor is decreased, the height of the shaft support system can be kept substantially the same, to better maintain verticality in the shaft of the motor and prevent wobbling in the disk.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

Many embodiments other than those set forth above can be found in the appended claims.

What is claimed is:

1. A motor comprising:
a rotor having a magnet coupled to an inside thereof, the rotor having a cylindrical portion protruding in a tubular shape from a center portion thereof;
a shaft having one end thereof coupled to the cylindrical portion, the one end of the shaft having an outer diameter greater than that of the other side;
a holder supporting the other end of the shaft, the holder having a portion thereof inserted in the cylindrical portion;
a bearing positioned between the holder and the other end of the shaft, the bearing rotatably supporting the other end of the shaft;
a stator adjacent to the magnet, the stator having a coil wound around a portion thereof; and
a base supporting the holder.

2. The motor of claim 1, wherein the holder and the bearing support the entire other end of the shaft.

3. The motor of claim 1, wherein the cylindrical portion has a constant inner diameter.

4. The motor of claim 1, wherein the holder has a hook formed on an outer perimeter thereof, the hook protruding outwards,
the rotor has a stopper formed on an inside thereof, the stopper configured to latch onto the hook, and
the hook is positioned outside the cylindrical portion.

5. The motor of claim 1, further comprising a chucking part surrounding the cylindrical portion and coupled to the rotor,
wherein the chucking part comprises:
a chuck base coupled to the cylindrical portion;
a plurality of chuck chips inserted in the chuck base such that the chuck chips protrude out from the chuck base; and
an elastic member positioned inside the chuck base, the elastic member elastically supporting a pair of adjacent chuck chips in an outward direction of the chuck base.

6. The motor of claim 5, wherein the elastic member is a compression coil spring.
